(19) United States
(12) Patent Application Publication
(10) Pub. No.: US 2024/0130010 A1
(43) Pub. Date: Apr. 18, 2024

(54) LIQUID HEATING DEVICE

(71) Applicant: Niterra Co., Ltd., Nagoya-shi, Aichi (JP)

(72) Inventors: Yusuke MAKINO, Nagoya-shi, Aichi (JP); Yuya HIGASHIDE, Nagoya-shi, Aichi (JP)

(73) Assignee: Niterra Co., Ltd., Nagoya-shi, Aichi (JP)

(21) Appl. No.: 18/277,436

(22) PCT Filed: May 2, 2022
(86) PCT No.: PCT/JP2022/019504

§ 371 Date: Aug. 16, 2023

(30) Foreign Application Priority Data
May 18, 2021 (JP) 2021-083538

(51) Int. Cl. H05B 3/82; H05B 3/48

(52) U.S. Cl. CPC H05B 3/82; H05B 3/48; H05B 2203/021

(57) ABSTRACT

A liquid heating device (200) including: a container (100) having an internal space (100i), inlet (103) and outlet (105); and a ceramic heater (171,172) of which base-end portion (17R) is retained by the container, the ceramic heater including ceramic sheet (17s) having a heat generation portion (17a) and being wrapped around an outer circumference of ceramic base (17g) such that, at a wrap-meeting part of the ceramic sheet, a slit (17v) extending in the axial-line L direction is formed as a non-heat generation portion, wherein the liquid is heated by the ceramic heater, the outlet is located apart from the inlet in the axial-line direction, and a first-axis n1 direction in a vicinity (105R) of an opening end (105e) facing the internal space, of the outlet, crosses the axial-line direction, and a front end of the heat generation portion is located on the base-end portion side relative to the outlet.

### TECHNICAL FIELD

The present invention relates to a liquid heating device which heats a liquid such as water by a ceramic heater.

### BACKGROUND ART

Warm water is needed for a warm water washing toilet seat, a fuel cell system, a water heater, a 24-hour bath system, heating of a washer fluid for a vehicle, an in-vehicle air conditioner, and the like. Accordingly, a liquid heating device which heats water by a built-in heater is used (Patent Document 1).

In particular, for the purpose of rapid heating for warm water of a warm water washing toilet seat, etc., or achieving downsizing of the liquid heating device, a rod-shaped ceramic heater having a heat generation portion embedded in a ceramic sheet wrapped around the outer circumference of an elongated ceramic base is used (Patent Document 2).

### PRIOR ART DOCUMENT

### Patent Document

Patent Document 1: Japanese Patent Application Laid-Open (kokai) No. 2008-96057
Patent Document 2: Japanese Patent No. 5923295

### SUMMARY OF THE INVENTION

### Problem to be Solved by the Invention

However, in the configuration described in Patent Document 1, an infrared lamp is used as a heater, and thus there is a problem that it is difficult to downsize the heater and therefore the liquid heating device. In addition, the infrared lamp leads to cost increase.

Meanwhile, the rod-shaped ceramic heater has the heat generation portion on the front-end side. Therefore, a base-end portion of the heater is retained in a cantilever manner by a container of the liquid heating device while being sealed by a sealing portion. The ceramic heater has excellent performance for rapid heating, but when warm water is produced, boiling bubbles are likely to be generated. If the boiling bubbles are accumulated around the heater, the heater is exposed at the accumulation part, so that local overheating is likely to occur in the container. Then, if the overheating occurs at a part near the sealing portion made of resin or the like, there is a possibility that the sealing portion softens and thus sealing property is deteriorated.

Further, if the ceramic heater is downsized and the heat generation area becomes small, the heater temperature needs to be more increased so as to generate the same amount of heat as in the conventional case, leading to increase in boiling bubbles generated when warm water is produced. In addition, if boiling bubbles contact with the ceramic heater, the contact part comes into a no-water heated state, so that the heater is thermally shocked, thus decreasing the heater life.

In this regard, in the configuration described in Patent Document 2, a ceramic heater is placed so as to stand vertically with a sealing portion located on the lower side. Therefore, even if boiling bubbles are generated at the heater near the sealing portion, the bubbles escape upward. However, there is a problem that this cannot be applied to a case of laying a ceramic heater horizontally.

Considering the above, it is required to inhibit boiling bubbles from staying at a ceramic heater near a sealing portion even in a case of laying the ceramic heater horizontally.

Accordingly, an object of the present invention is to provide a liquid heating device in which boiling bubbles generated from a ceramic heater are readily discharged to outside of a container, and deterioration in sealing property and decrease in the life of the ceramic heater are suppressed.

### Means for Solving the Problem

In order to solve the above problem, a liquid heating device of the present invention is a liquid heating device comprising: a container having an internal space, and an inlet and an outlet for a liquid which communicate with the internal space; and a ceramic heater of which a front-end portion is located in the internal space and of which a base-end portion is retained by the container so that the ceramic heater is attached to the container, the ceramic heater including a ceramic base extending in an axial-line direction and a ceramic sheet which has a heat generation portion and is wrapped around an outer circumference of the ceramic base such that, at a wrap-meeting part of the ceramic sheet, a slit extending in the axial-line direction is formed as a non-heat generation portion, wherein a gap is formed between the container and the ceramic heater, in a process in which the liquid is introduced from the inlet and flows through the internal space to the outlet, the liquid is heated by the ceramic heater, the outlet is located apart from the inlet in the axial-line direction, and a first-axis direction in a vicinity of an opening end facing the internal space, of the outlet, crosses the axial-line direction, and a front end of the heat generation portion is located on the base-end portion side relative to the outlet.

With this liquid heating device, in the structure in which the inlet and the outlet are located in the axial-line direction of the ceramic heater, water introduced from the inlet flows to the front-end portion side of the ceramic heater toward the outlet. Therefore, the water is unlikely to flow toward the sealing portion located on the base-end portion side of the ceramic heater. Thus, boiling bubbles can be inhibited from staying at the heater near the sealing portion.

In addition, since the outlet is placed such that the first-axis direction thereof crosses the axial-line-L direction, even in a case of laying the ceramic heater horizontally (axial-line direction is the horizontal direction), water heated by the container and therefore boiling bubbles are readily discharged to outside in a state in which the exit of the outlet is directed upward, whereby boiling bubbles can be further inhibited from staying at the heater near the sealing portion.

Moreover, since the front end of the heat generation portion is located on the base-end portion side relative to the outlet, boiling bubbles are inhibited from being accumulated in the vicinity of the outlet, whereby discharge of boiling bubbles to outside of the container can be further promoted.

Thus, boiling bubbles generated from the ceramic heater can be readily discharged to outside of the container, and deterioration in sealing property and decrease in the life of the ceramic heater can be suppressed.

In the liquid heating device of the present invention, the ceramic heater may have a watt density not less than 100 W/cm².

With this liquid heating device, since the ceramic heater has a high output, the ceramic heater and therefore the entire liquid heating device can be downsized. In addition, as the ceramic heater is more downsized, the heater temperature needs to be more increased, so that more boiling bubbles are generated. Therefore, the present invention becomes more effective.

In the liquid heating device of the present invention, a plurality of the ceramic heaters may be provided in the container, and the ceramic heaters may extend in the same direction, and the front ends of the heat generation portions of all the ceramic heaters may be located on the base-end portion side relative to the outlet.

With this liquid heating device, the present invention can be applied to a case of having a plurality of ceramic heaters.

In the liquid heating device of the present invention, the heat generation portion may be embedded in the ceramic sheet.

With this liquid heating device, production of the ceramic heater is facilitated.

### Advantageous Effects of the Invention

According to the present invention, boiling bubbles generated from a ceramic heater can be readily discharged to outside of a container, and deterioration in sealing property and decrease in the life of the ceramic heater can be suppressed.

### BRIEF DESCRIPTION OF THE DRAWINGS

FIG. 1 Perspective view showing the outer appearance of a liquid heating device according to an embodiment of the present invention.

FIG. 2 Perspective view showing the outer appearance of a ceramic heater.

FIG. 3 Exploded perspective view showing the configuration of the ceramic heater.

FIG. 4 See-through view along line A-A in FIG. 1.

FIG. 5 Perspective view showing a first opening face of an inlet.

FIG. 6 Sectional view showing flow of water in a case where a front end of a heat generation portion faces the outlet.

FIG. 7 Sectional view along line B-B in FIG. 1.

FIG. 8 Sectional view along line C-C in FIG. 7.

FIG. 9 Sectional view along line D-D in FIG. 7.

FIG. 10 Sectional view along line E-E in FIG. 7.

### MODES FOR CARRYING OUT THE INVENTION

Hereinafter, an embodiment of the present invention will be described.

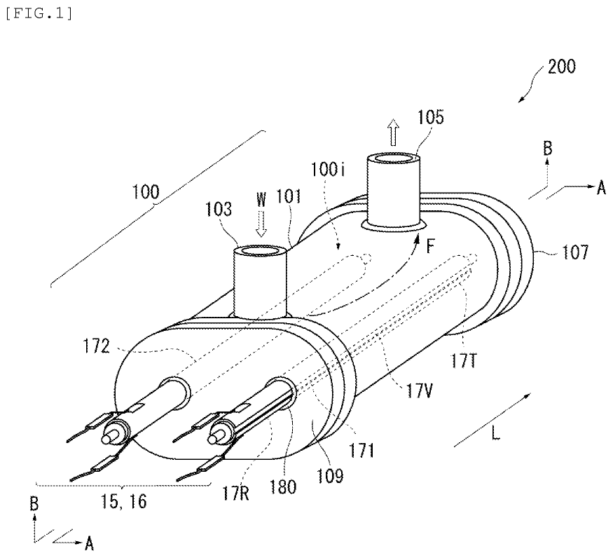

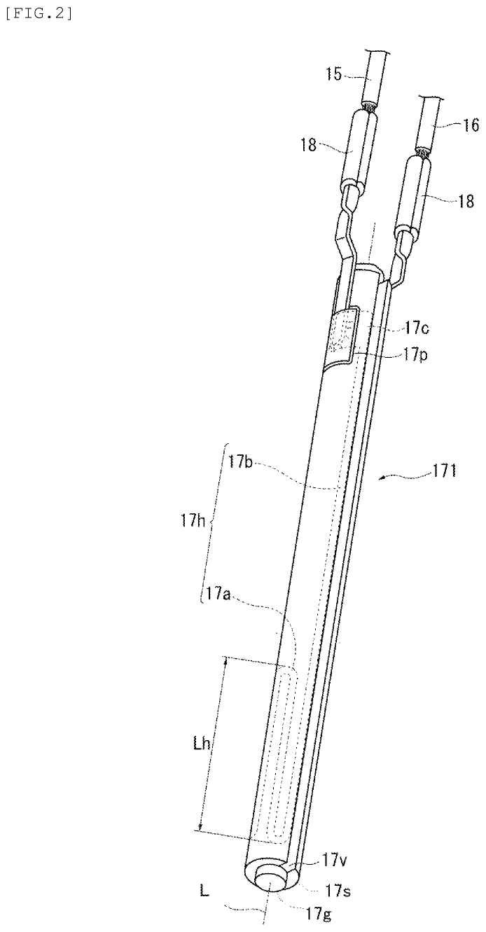

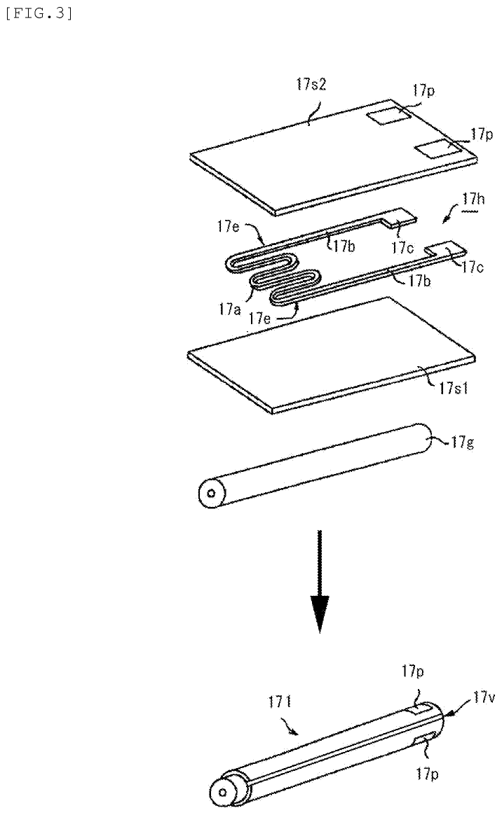

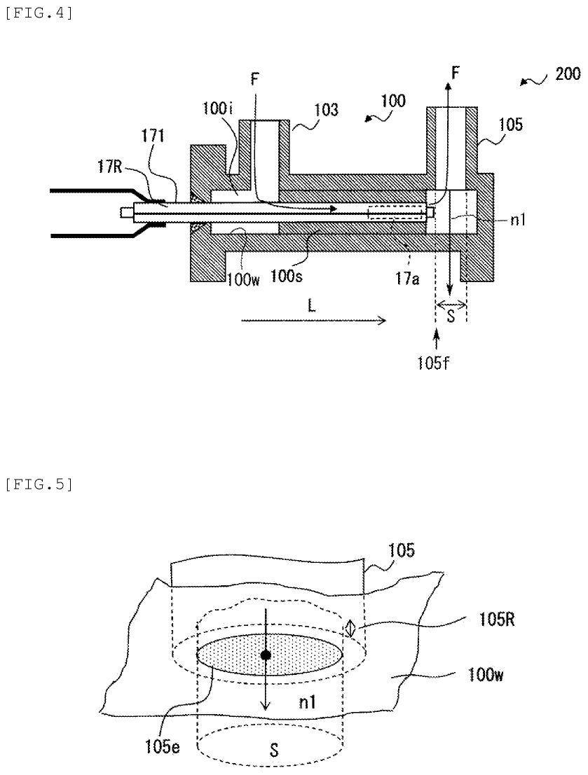

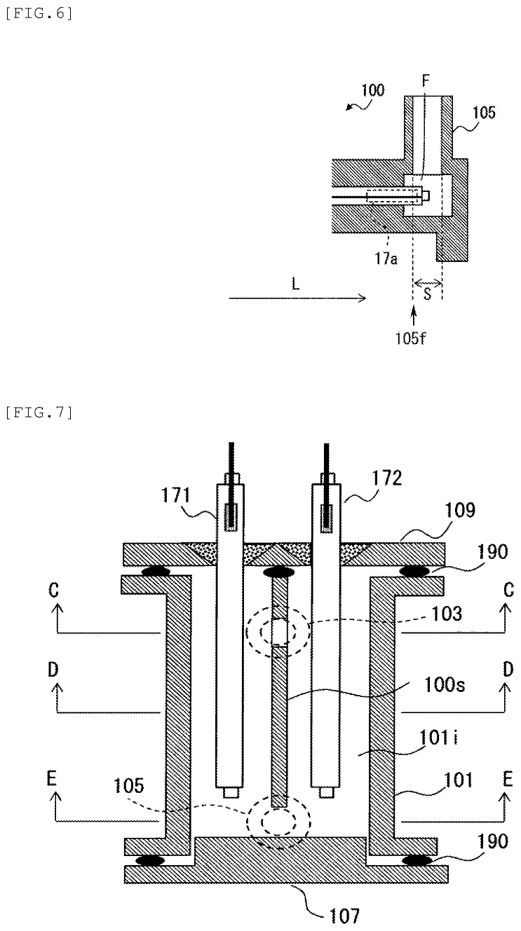

FIG. 1 is a perspective view of a liquid heating device 200 according to the embodiment of the present invention. FIG. 2 is a perspective view of a ceramic heater 171. FIG. 3 is an exploded perspective view of the ceramic heater 171. FIG. 4 is a see-through view along line A-A in FIG. 1. FIG. 5 is a perspective view showing a first opening face S of an outlet 105. FIG. 6 is a sectional view showing flow of water in a case where a front end of a heat generation portion 17a faces the outlet 105.

In this embodiment, the liquid heating device 200 is provided to a warm water washing toilet seat, and heats ordinary-temperature water by two built-in ceramic heaters 171, 172, to supply warm water.

The liquid heating device 200 has substantially an oblong tubular shape (a tubular shape whose cross-section is a rectangle with rounded corners) in its entirety, and has a container 100 and the two ceramic heaters 171, 172.

The container 100 has an oblong tubular trunk portion 101 having an internal space 100i for storing a liquid W (water), a front-end lid 107 and a rear-end lid 109 that close openings at both ends in the axial direction of the trunk portion 101, and an inlet 103 and the outlet 105 for the liquid W which are provided integrally with the trunk portion 101.

Both ends in the axial direction of the trunk portion 101 protrude in a flange shape in the radial direction. Both ends of the trunk portion 101, and the front-end lid 107 and the rear-end lid 109, are respectively sealed with each other in an airtight state by O rings 190 (FIG. 7).

The ceramic heaters 171, 172 have rod shapes extending in an axial-line-L direction, and are arranged side by side toward the same direction (in parallel). A base-end portion 17R of each ceramic heater 171, 172 is retained in a cantilever manner by a sealing portion 180 at an opening of the rear-end lid 109 of the container 100, whereby each ceramic heater 171, 172 is attached to the container 100. A front-end portion 17T of each ceramic heater 171, 172 is located in the internal space 100i. Needless to say, the retained part by the sealing portion 180 is on the base-end side relative to the heat generation portion 17a of the ceramic heater described later.

Here, the state in which the ceramic heaters 171, 172 are arranged side by side toward the same direction (in parallel) means that the greatest value of angles formed by axial lines of all the ceramic heaters 171, 172 is not greater than 10 degrees (including 0 degrees), in consideration of error in installation, and the like.

Lead wires 15, 16 described later for supplying power from outside are connected to the base-end portion 17R sides of the ceramic heaters 171, 172.

In this example, the axial direction of the trunk portion 101 is parallel to the axial-line-L direction, and the ceramic heaters 171, 172 are stored in the internal space 100i of the trunk portion 101 such that the direction in which the ceramic heaters 171, 172 are arranged side by side is along the major axis of the cross-section of the trunk portion 101. However, the axial direction of the trunk portion 101 may have a small predetermined angle with respect to the axial-line-L direction.

Although not shown, in this example, the liquid heating device 200 is provided to the warm water washing toilet seat such that the axial-line-L direction is substantially the horizontal direction and the outlet 105 side is located slightly upward, and the ceramic heaters 171, 172 are laid horizontally.

The inlet 103 and the outlet 105 communicate with the internal space 100i and are located apart from each other in the axial-line-L direction (also corresponding to the axial direction of the trunk portion 101). The liquid W introduced through the inlet 103 from outside passes through the internal space 100i along a flow direction F and then is discharged from the outlet 105.

A gap is formed between the inner wall of the container 100 and each ceramic heater 171, 172. The liquid W introduced into the internal space 100i through the inlet 103 contacts with the outer surfaces of the ceramic heaters 171, 172 along the axial-line-L direction, thus being heated, and then the liquid W flows to the outlet 105.

Next, with reference to FIG. 2 and FIG. 3, the configuration of the ceramic heater will be described. The ceramic heaters 171, 172 have the same shape and therefore the ceramic heater 171 will be described.

As shown in FIG. 2, the ceramic heater 171 has a heat generation body 17h which generates heat by being energized from outside via the lead wires 15, 16. The heat generation body 17h has, on the front-end side, the heat generation portion 17a formed by meandering a conductor in the axial-line-L direction as a heat generation pattern, and has a pair of lead portions 17b led from both ends of the heat generation portion 17a to the rear-end side.

The heat generation portion 17a has a length of Lh in the axial-line-L direction.

More specifically, as shown in FIG. 3, the heat generation body 17h has the heat generation portion 17a, both lead portions 17b, and electrode patterns 17c formed at rear ends of both lead portions 17b, and the heat generation body 17h is held between two ceramic green sheets 17s1, 17s2. As the ceramic green sheets, alumina is used. As the heat generation portion 17a and the lead portions 17b, tungsten, rhenium, or the like is used. Two electrode pads 17p to which lead terminals 18 (see FIG. 2) are to be brazed are formed on the front surface of the ceramic green sheet 17s2, and the electrode patterns 17c are connected to the electrode pads 17p via through holes, thus forming a laminated body of the ceramic green sheets.

Further, this laminated body is wrapped around a rod-shaped ceramic base 17g mainly composed of alumina, etc., with the ceramic green sheet 17s2 set on the front side, and then these are sintered, whereby the ceramic green sheets 17s1, 17s2 form a ceramic sheet 17s wrapped around the outer circumference of the ceramic base 17g so as to be integrated and thus the ceramic heater 171 can be produced.

The lead wires 15, 16 are crimped with the lead terminals 18 so as to be electrically connected thereto (see FIG. 2).

In this example, the ceramic base 17g is solid, but may have a tubular shape. In a case of a tubular shape, it is desirable to make sealing with resin or the like so as not to leak water from the through hole.

Here, in wrapping the laminated body around the ceramic base 17g, the laminated body is wrapped such that both ends along the axial-line-L direction of the laminated body are spaced from each other. Thus, at a wrap-meeting part on the outer surface of the ceramic heater 171, a slit 17v forming a recessed groove along the axial-line-L direction is formed as a non-heat generation portion.

Therefore, as seen in the cross-section of the ceramic heater 171 along the radial direction, the heat generation portion 17a is embedded in the ceramic heater 171 so as to form a ring shape having ends, and the slit 17v as a non-heat generation portion is formed between two ring ends 17e of the heat generation portion 17a.

Alternatively, without the ceramic green sheet 17s1, the heat generation body 17h may be formed by printing or the like on the back-surface side of the ceramic green sheet 17s2, and the ceramic green sheet 17s2 may be wrapped, with the heat generation body 17h side facing the ceramic base 17g. In this case, the heat generation body 17h (heat generation portion 17a) is placed between the ceramic base 17g and the ceramic green sheet 17s2.

On the other hand, in the configuration in FIG. 3, the heat generation body 17h (heat generation portion 17a) is held between the ceramic green sheets 17s1, 17s2, i.e., “embedded” in the ceramic sheet.

As described above, the case where the heat generation portion 17a is embedded in the ceramic sheet (ceramic green sheets 17s1, 17s2) and the case where the heat generation portion 17a is placed between the ceramic base 17g and the ceramic green sheet 17s2, are collectively expressed as “the ceramic sheet has the heat generation portion”.

Next, with reference to FIG. 4 to FIG. 6, the detailed configuration of the liquid heating device 200 will be described.

As shown in FIG. 4, a first-axial-line-n1 direction of the outlet 105 crosses the axial-line-L direction of the ceramic heaters 171, 172 (in this example, perpendicular to the axial-line-L direction). FIG. 4 is a view as seen through in a direction perpendicular to the axial-line-L direction and the axial line of the outlet 105. The “axial-line-L direction” compared with the first normal n1 is an average direction of the respective axial-line-L directions of the ceramic heaters 171, 172.

Here, as shown in FIG. 5, the first axis n1 is an axis in a vicinity 105R of an opening end 105e facing the internal space 100i, of the outlet 105, and the opening end 105e is the boundary between an inner peripheral surface 100w of the container 100 and the outlet 105. The boundary is a part where the curvature sharply changes from the inner peripheral surface 100w near the outlet 105.

The “vicinity 105R of the opening end 105e” refers to an inner wall of the outlet 105 that includes the opening end 105e and is located on the downstream side of the opening end 105e. The “first axis n1” is the axis of the columnar body formed by the above inner wall and passes the center of gravity in the cross-section of the columnar body.

FIG. 5 is a view as seen from the internal space 100i side of the container 100 toward the outlet 105. In this example, the opening end 105e has a circular shape.

Here, the reason why the “first axis n1 in the vicinity 105R” is defined is that, in the present invention, the direction of the liquid W flowing from the internal space 100i toward the opening end 105e of the outlet 105 is important. That is, flow of the liquid W from the opening end 105e toward outside is regulated by the direction of the inner wall of the outlet 105 in the vicinity 105R, and therefore the direction of the “first axis n1 in the vicinity 105R” is important.

Further, as shown in FIG. 4, the front end of the heat generation portion 17a is located on the base-end portion 17R side relative to the outlet 105.

Here, the “base-end portion 17R side relative to the outlet 105” refers to the base-end portion 17R side relative to an edge portion 105f, of the first opening area S of the outlet 105, that is closest to the base-end portion 17R side.

The “first opening area S” is an area where the opening end 105e is projected in the first-axis-n1 direction.

Thus, in the structure in which the inlet 103 and the outlet 105 are located in the axial-line-L direction of the ceramic heaters 171, 172, water introduced from the inlet 103 flows along the flow direction F to the front-end portion 17T sides of the ceramic heaters 171, 172 toward the outlet 105. Therefore, the water is unlikely to flow toward the sealing portions 180 located on the base-end portion 17R sides of the ceramic heaters 171, 172. Thus, boiling bubbles can be inhibited from staying at the heaters near the sealing portions 180.

In addition, since the outlet 105 is placed such that the first-axis-n1 direction thereof crosses the axial-line-L direction, even in a case of laying the ceramic heaters 171, 172 horizontally (axial-line-L direction is the horizontal direction), water heated by the container 100 and therefore boiling bubbles are readily discharged to outside in a state in which the exit of the outlet 105 is directed upward, whereby boiling bubbles can be further inhibited from staying at the heaters near the sealing portions 180.

Moreover, since the front end of the heat generation portion 17a is located on the base-end portion 17R side relative to the outlet 105, when the liquid W flows along the flow direction F, boiling bubbles are inhibited from being accumulated in the vicinity of the outlet 105, whereby discharge of boiling bubbles to outside of the container 100 can be further promoted.

On the other hand, as shown in FIG. 6, if the front end of the heat generation portion 17a faces the outlet 105 (first opening face S thereof), there is a problem that discharge of boiling bubbles to outside of the container 100 is stagnated.

From the above overall description, according to the present embodiment, boiling bubbles generated from the ceramic heater can be readily discharged to outside of the container, and deterioration in sealing property and decrease in the life of the ceramic heater can be suppressed.

Here, setting the ceramic heaters 171, 172 to have a watt density not less than 100 W/cm² is preferable because the ceramic heaters and therefore the entire liquid heating device 200 can be downsized.

In addition, as the ceramic heater is more downsized, the heater temperature needs to be more increased, so that more boiling bubbles are generated. Therefore, the present invention becomes more effective.

With reference to FIG. 7 to FIG. 10, the rest of the configuration of the liquid heating device 200 will be described.

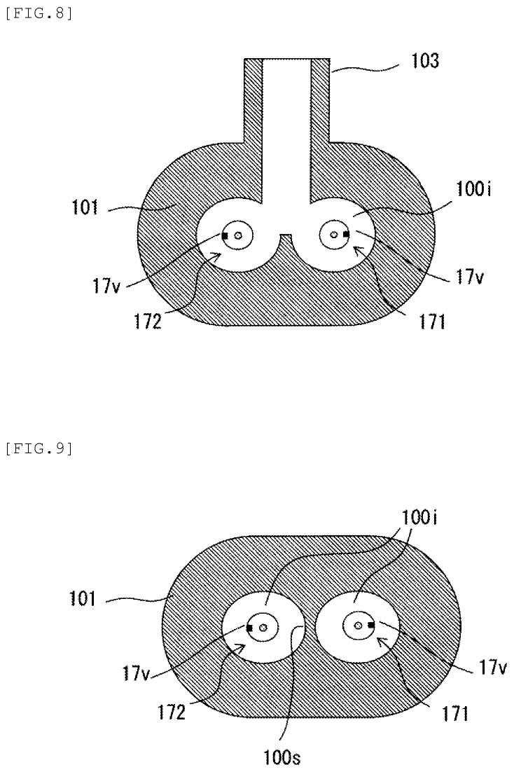

As shown in FIG. 8, the slits 17v of the ceramic heaters 171, 172 face outer sides in the major-axis direction of the container 100 which are sides far from the inlet 103.

Thus, in the structure in which the inlet 103 and the outlet 105 are arranged in the axial-line-L direction of the ceramic heaters 171, 172, the slits 17v are not present (do not oppose) at the liquid that first collides with the outer surfaces of the ceramic heaters 171, 172 from the inlet 103 at a high flow speed, and therefore the liquid first introduced into the internal space 100i is effectively heated by the heat generation portions 17a. As a result, the entire water is uniformly heated, so that heating efficiency is improved.

As shown in FIG. 9, in the internal space 100i between the inlet 103 and the outlet 105, a separation wall 100s is provided for separating the plurality of ceramic heaters 171, 172 one by one from each other, so that the water introduced from the inlet 103 flows for each ceramic heater 171, 172 in the separation wall 100s.

Thus, the water flows through narrow gaps in the separation wall 100s and is heated by each ceramic heater 171, 172, whereby heating efficiency is further improved.

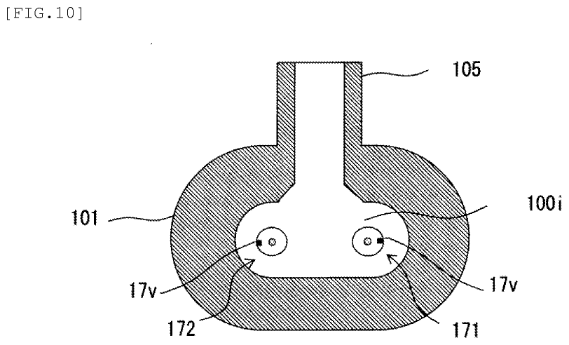

As shown in FIG. 10, in the internal space 100i near the outlet 105, the separation wall 100s is not provided and therefore a single internal space 100i is formed.

Thus, near the outlet 105, the volume of the internal space 100i increases, so that boiling bubbles generated on the inlet 103 side is readily discharged from the outlet 105 to outside. In addition, flows of water heated in each individual separation wall 100s merge together, thus obtaining warm water having uniform temperature.

FIG. 7 is a sectional view taken along the axial-line-L direction so as to pass the center of the minor axis of the liquid heating device 200. FIG. 8, FIG. 9, and FIG. 10 are sectional views perpendicular to the axial-line-L direction in FIG. 7.

It should be understood that the present invention is not limited to the above embodiment and incorporates various modifications and equivalents within the idea and the scope of the present invention.

For example, the shapes of the liquid heating device and the ceramic heater are not limited. The number of ceramic heaters provided to the liquid heating device may be one, or three or more.

### Example

The liquid heating device 200 shown in FIG. 1 was produced.

First, as raw-material ceramic for the ceramic heater, alumina powder and glass-component powder serving as a sintering aid were crushed and mixed with water by a mill, and then were mixed with a binder, to obtain a clay-like mixture. The clay-like mixture was extruded by an extruder using a die with a core placed therein, to form a tubular ceramic base, which was then cut into a predetermined length and calcined. The outer diameter and the length of the ceramic base were adjusted in consideration of a sintering shrinkage factor.

Meanwhile, on an alumina green sheet, a heater pattern and a terminal portion connected thereto and leading to a sheet opposite surface were printed and formed using a tungsten/molybdenum paste. Regarding the size of the heater printed area, dimensions were prescribed while a shrinkage factor in ceramic sintering was taken into consideration. The heater pattern was formed while calculating a resistance value at the room temperature from a resistance value at a high temperature and a resistance change amount (temperature coefficient of resistance×temperature difference×initial resistance value) corresponding to temperature increase. Also for the sheet size, a sintering shrinkage factor was considered, to prepare and cut the sheet.

The printed ceramic green sheet cut in a prescribed size was wrapped around the calcined ceramic base, and these were sintered integrally, thus obtaining a ceramic heater having a heater entire length of 60 mm, a heater area length of 30 mm, an outer diameter of 2.8 mm, and a room-temperature resistance value of 9Ω in a completed state. An exposed terminal portion of the heater sintered body was plated with Ni, and a lead portion made of Ni was brazed and joined thereto by Ag solder. Then, the lead wire was crimped with the lead portion, thus obtaining the ceramic heater.

Next, two ceramic heaters were attached to a container made of resin. Specifically, the respective ceramic heaters were caused to penetrate two through holes of the rear-end lid, and the ceramic heaters were fixed using an epoxy adhesive as the sealing portions. Then, the rear-end lid, the trunk portion, and the front-end lid were connected in an airtight state via O rings, thus producing the liquid heating device 200.

To the obtained liquid heating device 200, water having a temperature of 5° C. was introduced at a flow rate of 450 cc/min, and application voltage per ceramic heater was controlled so that the flow-out warm-water temperature became 35° C.

As a result, the sealing portions were constantly immersed in water, and boiling bubbles never stayed near the sealing portions. In addition, while water continuously flowed at the above flow rate through the liquid heating device 200, voltage was applied for 15 seconds and then the application was stopped for 15 seconds. Even when this cycle was consecutively repeated for 10 cycles, warm water was normally obtained. In this process, resistance value changes of the respective heaters were equivalent, and therefore it is considered that the respective heater temperatures were equivalent.

### DESCRIPTION OF REFERENCE NUMERALS

17a heat generation portion
17g ceramic base
17s ceramic sheet
17T front-end portion of ceramic heater
17R base-end portion of ceramic heater
17v slit
100 container
100i internal space
100w inner peripheral surface of the container
103 inlet
105 outlet
105e opening end of the outlet
105R vicinity of the opening end
171,172 ceramic heater
200 liquid heating device
L axial-line
S first opening area
n1 first axis
W liquid

1. A liquid heating device comprising:
a container having an internal space, and an inlet and an outlet for a liquid which communicate with the internal space; and
a ceramic heater of which a front-end portion is located in the internal space and of which a base-end portion is retained by the container so that the ceramic heater is attached to the container, the ceramic heater including a ceramic base extending in an axial-line direction and a ceramic sheet which has a heat generation portion and is wrapped around an outer circumference of the ceramic base such that, at a wrap-meeting part of the ceramic sheet, a slit extending in the axial-line direction is formed as a non-heat generation portion, wherein
a gap is formed between the container and the ceramic heater,
in a process in which the liquid is introduced from the inlet and flows through the internal space to the outlet, the liquid is heated by the ceramic heater,
the outlet is located apart from the inlet in the axial-line direction, and a first-axis direction in a vicinity of an opening end facing the internal space, of the outlet, crosses the axial-line direction, and
a front end of the heat generation portion is located on the base-end portion side relative to the outlet.

2. The liquid heating device according to claim 1, wherein
the ceramic heater has a watt density not less than 100 W/cm².

3. The liquid heating device according to claim 1, wherein
a plurality of the ceramic heaters are provided in the container, and the ceramic heaters extend in the same direction, and
the front ends of the heat generation portions of all the ceramic heaters are located on the base-end portion side relative to the outlet.

4. The liquid heating device according to claim 1, wherein
the heat generation portion is embedded in the ceramic sheet.
